(19) United States
(12) Patent Application Publication
(10) Pub. No.: US 2017/0242286 A1
(43) Pub. Date: Aug. 24, 2017

(54) Display Having Column Spacer Structures with Minimized Plastic Deformation

(71) Applicant: Apple Inc., Cupertino, CA (US)

(72) Inventors: Xiaokai Li, Cupertino, CA (US); Young Cheol Yang, Sunnyvale, CA (US); Shaorui Yang, San Jose, CA (US); Da Yu, San Jose, CA (US); Jin Yan, Santa Clara, CA (US)

(21) Appl. No.: 15/237,489

(22) Filed: Aug. 15, 2016

Related U.S. Application Data
(60) Provisional application No. 62/297,378, filed on Feb. 19, 2016.

(51) Int. Cl. G02F 1/1339; G02F 1/1368; G02F 1/1335

(52) U.S. Cl. CPC G02F 1/13394; G02F 1/133514; G02F 1/133512; G02F 1/133528; G02F 1/1368; G02F 2001/13396; G02F 2001/133519; G02F 2001/133302

(57) ABSTRACT

A display may have a color filter layer and a thin-film transistor layer. A liquid crystal layer may be interposed between the color filter layer and the thin-film transistor layer. Column spacer structures may be used to maintain a desired gap for the liquid crystal layer between the color filter layer and the thin-film transistor layer. The column spacer structures may include column spacers having bases and opposing tips. The tips may penetrate into the liquid crystal layer and may bear against the thin-film transistor layer or aligned column spacer pads on the thin-film transistor layer. The color filter layer may have a glass substrate, a black matrix on the substrate, a color filter element layer on the black matrix, and an overcoat on the color filter element layer. Some or all of the column spacers may have bases that contact the black matrix layer.

This application claims the benefit of provisional patent application No. 62/297,378, filed Feb. 19, 2016, which is hereby incorporated by reference herein in its entirety.

### BACKGROUND

This relates generally to electronic devices, and more particularly, to electronic devices with displays.

Electronic devices often include displays. For example, cellular telephones and portable computers often include displays for presenting information to a user.

Liquid crystal displays contain a layer of liquid crystal material. Pixels in a liquid crystal display contain thin-film transistors and electrodes for applying electric fields to the liquid crystal material. The strength of the electric field in a pixel controls the polarization state of the liquid crystal material and thereby adjusts the brightness of the pixel.

Substrate layers such as color filter layers and thin-film transistor layers are used in liquid crystal displays. The thin-film transistor layer contains an array of the thin-film transistors that are used in controlling electric fields in the liquid crystal layer. The color filter layer contains an array of color filter elements such as red, blue, and green elements. The color filter elements color the light passing through the pixels and provides the display with the ability to display color images.

In an assembled display, the layer of liquid crystal material is sandwiched between the thin-film transistor layer and the color filter layer. The color filter has a black matrix formed from a layer of opaque polymer with an array of pixel openings. A color filter element layer on the black matrix layer is patterned to form color filter elements in the openings of the black matrix. A planarizing polymer overcoat layer covers the color filter elements. An array of polymer column spacers is formed on the surface of the color filter layer to maintain a desired gap between the color filter layer and the thin-film transistor layer.

During use of an electronic device, forces may sometimes be exerted on portions of a display. If an applied force is small, the column spacer structures will deform elastically and will return to their original heights after the force is removed. If, however, the applied force is substantial, the column spacers will be deformed plastically and will exhibit permanent reductions in their heights. If the amount of plastic deformation is significant, the column spacers will not be able to separate the color filter layer and thin-film layer by an appropriate gap. This can lead to undesired visible artifacts on the display such as gray spots.

It would therefore be desirable to be able to provide improved column spacer arrangements for displays.

### SUMMARY

An electronic device may have a display. The display may have upper and lower polarizers. The display may also have layers such as a color filter layer and a thin-film transistor layer that are interposed between the upper and lower polarizers. A liquid crystal layer may be interposed between the color filter layer and the thin-film transistor layer.

During operation of the display, a user's finger or other external objects may press against the surface of the display. This tends to deform the outer portion of the display inwards and can compress the liquid crystal layer. Column spacer structures may be used to maintain a desired gap between the color filter layer and the thin-film transistor layer for the liquid crystal layer. To avoid undesirable permanent damage to the display, column spacer structures are preferably formed so as to exhibit minimized plastic deformation.

The column spacer structures may include column spacers having bases and opposing tips. The tips of the column spacers may penetrate into the liquid crystal layer and may bear against the thin-film transistor layer or column spacer pads on the thin-film transistor layer.

The color filter layer may have a glass substrate, a black matrix on the glass substrate, a color filter element layer on the black matrix, and an overcoat on the color filter element layer. Some or all of the column spacers may have bases that contact the black matrix layer and thereby avoid plastic deformation of the color filter element layer and overcoat layer when force is applied.

The color filter element layer and overcoat layer may be formed from polymer such as acrylic. The column spacers and the column spacer pads may also be formed from a polymer such as acrylic. To help resist undesired plastic deformation when force is applied to the display, the column spacers may have a plasticity that is less than the plasticity of the color filter element layer and overcoat layer.

### BRIEF DESCRIPTION OF THE DRAWINGS

FIG. 1 is a diagram of an illustrative electronic device having a display in accordance with an embodiment.

FIG. 2 is a cross-sectional side view of an illustrative display such as a liquid crystal display in accordance with an embodiment.

FIG. 3 is a diagram of an illustrative liquid crystal display in accordance with an embodiment.

FIGS. 4, 5, 6, and 7 are cross-sectional side views of illustrative displays with column spacers in accordance with embodiments.

FIG. 8 is a diagram showing illustrative operations involved in forming column spacers in accordance with embodiments.

FIG. 9 is a top view of an illustrative column spacer formed on a portion of a black matrix in a display in accordance with an embodiment.

### DETAILED DESCRIPTION

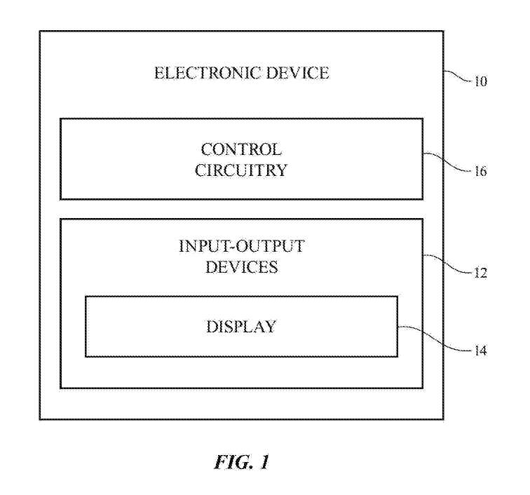

An illustrative electronic device of the type that may be provided with a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment.

As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. A touch sensor for display 14 may be formed from electrodes formed on a common display substrate with the pixels of display 14 or may be formed from a separate touch sensor panel that overlaps the pixels of display 14. If desired, display 14 may be insensitive to touch (i.e., the touch sensor may be omitted).

Control circuitry 16 may be used to run software on device 10 such as operating system code and applications. During operation of device 10, the software running on control circuitry 16 may display images on display 14.

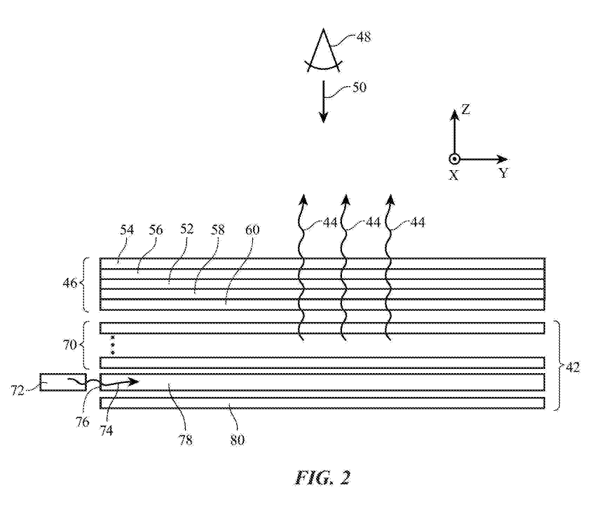

Display 14 may be a liquid crystal display. A cross-sectional side view of an illustrative liquid crystal display is shown in FIG. 2. Display 14 of FIG. 2 may have a rectangular shape (i.e., display 14 may have a rectangular footprint and a rectangular peripheral edge that runs around the rectangular footprint) or may have other suitable shapes. Display 14 may be planar, as shown in FIG. 2, or may have a curved profile.

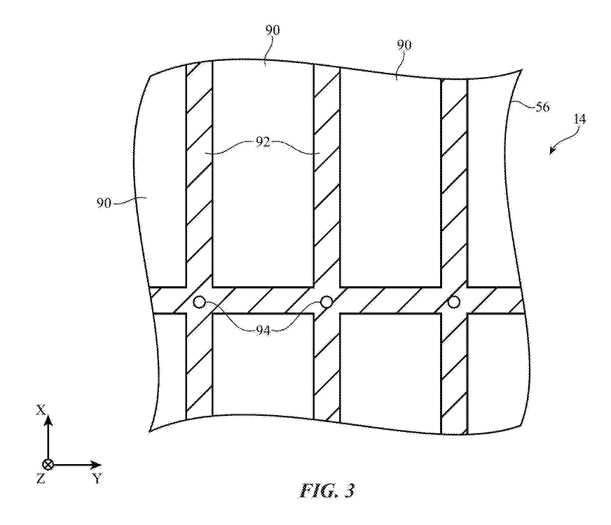

As shown in FIG. 2, display 14 may include backlight structures such as backlight unit 42 for producing backlight illumination such as backlight 44. During operation, backlight 44 travels outwards (vertically upwards in dimension Z in the orientation of FIG. 3) and passes through an array of pixels in display layers 46. This illuminates any images that are being produced by the pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 may form a liquid crystal display or may be used in forming displays of other types.

In a liquid crystal display, display layers 46 may include a liquid crystal layer such a liquid crystal layer 52. Liquid crystal layer 52 may be sandwiched between display layers such as display layers 58 and 56. Layers 56 and 58 may be interposed between lower polarizer layer 60 and upper polarizer layer 54.

Layers 58 and 56 may be formed from transparent substrate layers such as clear layers of glass or plastic. Layers 58 and 56 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of pixel circuits based on thin-film transistors and associated electrodes (pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer. Configurations in which color filter elements are combined with thin-film transistor structures on a common substrate layer in the upper or lower portion of display 14 may also be used.

In each of these scenarios, column spacers on layer 56 and/or layer 58 may help separate layers 56 and 58 from each other and thereby ensure a desired gap between layers 56 and 58 for liquid crystal layer 52. The performance of display 14 may be enhanced by accurately maintaining the thickness of layer 52 in this way. Failure to maintain a desired thickness for layer 52 may lead to gray spots or other undesired visible artifacts.

Backlight structures 42 may include a light guide layer such as light guide layer 78 (sometimes referred to as a light guide structure or light guide). Light guide layer 78 may be formed from one or more stacked layers of transparent material such as clear glass or plastic (e.g., molded plastic that forms a light guide plate, a thin flexible plastic film, etc.). During operation of backlight structures 42, light sources such as light source 72 may generate light that creates backlight 44. Light source 72 may be an array of light-emitting diodes that runs along one or more edges of light guide layer 78 such as edge 76 of light guide layer 78 (i.e., into the page along the X axis in the orientation of FIG. 2). Light-source 72 may emit light 74 into edge 76 of light guide layer 78.

Light 74 may be distributed throughout light guide layer 78 due to the principal of total internal reflection. Scattering features (protrusions, recesses, etc.) may be incorporated into light guide layer 78 (e.g., on the upper and/or lower surface of layer 78) to scatter light from layer 78. Light that is scattered upwards in direction Z from light guide layer 78 may serve as backlight 44 for display 14. Light that scatters downwards may be reflected back in the upwards direction by reflector 80. Reflector 80 may be formed from a reflective material such as a layer of plastic covered with a dielectric mirror thin-film coating. To enhance backlight performance for backlight structures 42, backlight structures 42 may include optical films 70. Optical films 70 may include diffuser layers for helping to homogenize backlight 44 and thereby reduce hotspots and light collimating films such as prism films (sometimes referred to as brightness enhancement films) and turning films for directing backlight 44 towards direction Z. Optical films 70 may overlap the other structures in backlight unit 42 such as light guide layer 78 and reflector 80. For example, if light guide layer 78 has a rectangular footprint in the X-Y plane of FIG. 2, optical films 70 and reflector 80 may have a matching rectangular footprint. If desired, films such as compensation films may be incorporated into other layers of display 14 (e.g., a reflective polarizer layer).

Display 14 may have a black matrix. The black matrix may have an array of openings corresponding to the array of pixels in display 14. Each opening may be provided with a color filter element. The color filter elements of display 14 may be red, green, and blue color filter elements and/or may include color filter element structures of other colors. The black matrix may be formed from a patterned layer of opaque masking material such as a patterned layer of black photoimageable polymer (e.g., a dark photosensitive acrylic). Using photolithography, the black matrix layer can be patterned to form a desired array of openings for the color filter elements.

The black matrix may be formed on the underside of the substrate in color filter layer 56. FIG. 3 is a diagram of a portion of color filter layer 56 as viewed in direction Z. As shown in FIG. 3, black matrix 92 may have an array of openings 90 corresponding to the pixels of display 14. Each opening 90 may be overlapped by a respective color filter element (e.g., a red, green, or blue color filter element). Black matrix 92 of FIG. 3 has intersecting horizontal and vertical strips of opaque material and forms an array of rectangular openings 90, but black matrix 92 may, in general, have any suitable shape. The configuration of FIG. 3 is merely illustrative.

The array of color filter elements in openings 90 may be formed by patterning color filter element material onto layer 56 after black matrix 92 has been formed. For example, in an arrangement in which display 14 has red, green, and blue color filter elements, a red photoimageable polymer layer may be deposited on the black matrix layer and patterned using photolithography to form a series of red color filter elements in a set of openings 90 that correspond to red pixels. This process may then be repeated for the green and blue color filter elements, so that an array of red, green, and blue color filter elements cover all of openings 90.

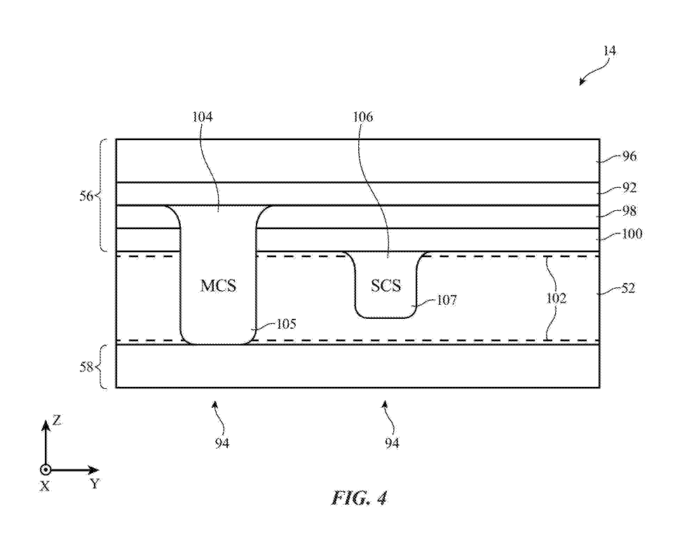

After the black matrix and color filter element layers have been patterned onto the substrate of layer 56, a planarizing organic layer such as a polymer overcoat layer may be deposited onto layer 56 over the black matrix and color filter elements. FIG. 4 is a cross-sectional side view of display 14 showing how black matrix 92, color filter element layer 98, and overcoat layer 100 may be formed on the surface of substrate layer 96.

As shown in FIG. 4, liquid crystal alignment layers 102 may be deposited over the innermost surfaces of layers 56 and 58. These alignment layers may be formed from a polymer such as polyimide or other suitable materials and may have a thickness of about 1000 angstroms. The black matrix layer, color filter element layer, and overcoat layer in display 14 are typically on the order of microns in thickness and are therefore substantially thicker than liquid crystal alignment layers 102. Liquid crystal alignment layers 102 may therefore sometimes be omitted from the drawings for clarity.

Column spacers 94 may be formed on layer 56 to prevent layer 56 from directly contacting each other and thereby maintaining a desired thickness for liquid crystal layer 52. To block column spacers 94 from view by viewer 48, column spacers 94 may be formed at locations that overlap black matrix 92. In the example of FIG. 3, column spacers 94 are formed at the intersections of the horizontal and vertical black matrix lines of black matrix 92. If desired, column spacers 92 may be formed on other portions of black matrix 92 or elsewhere on display 14. The example of FIG. 3 is merely illustrative.

The cross-sectional side view of display 14 in FIG. 4 shows how column spacers 94 may be used to separate layers 56 and 58. In the example of FIG. 4, column spacers 94 are formed on upper layer 56 (e.g., a color filter layer). Configurations in which column spacer pads or other column spacer structures are formed on lower layer 58 (e.g., a thin-film transistor layer) may also be used for forming display 14. If desired, column spacers 94 may be used in displays in which color filter and thin-film transistor structures are formed on a common substrate. The configuration of FIG. 4 is presented as an example.

Substrate layer 96 of color filter layer 56 of FIG. 4 may be a layer of clear glass, transparent plastic, or other clear substrate material. Black matrix 92 may be formed from a patterned layer of black matrix material on the inner surface of substrate layer 96. Color filter layer 98 may include patterned red, green, and blue color filter elements or color filter elements of other suitable colors and may be formed over black matrix 92. Overcoat layer 100 may be formed over color filter element layer 98 and may help planarize and protect the underlying color filter and black matrix layers. Liquid crystal alignment layers 102 may be formed on the inner surfaces of layers 56 and 58.

Column spacers 94 may be formed from photoimageable polymer and may be patterned using photolithography. As shown in FIG. 4, display 14 may have column spacers 94 such as main column spacers MCS having a height sufficient to allow main column spacers MCS to extend across liquid crystal layer 52 and may have shorter column spacers such as subspacers SCS that extend only partway across layer 52. The height of main column spacers MCS defines the size of the gap between layers 56 and 58 and therefore defines the thickness of liquid crystal layer 52.

Each column spacer has a tip and a base. For example, column spacer MCS has base 104 and opposing tip 105. Base 104 is supported by layer 56. Tip 105 protrudes into liquid crystal layer 52. Subspacer SCS has a base such as base 106 that is supported on layer 56 and an opposing tip such as tip 107 that penetrates into liquid crystal layer 52. During normal operation of display 14 when no external pressure is being applied to the surface of display 14, tips 105 of main column spacers MCS bear against thin-film transistor layer 58 and maintain a desired thickness for layer 52, while subspacers SCS are suspended away from layer 56.

In the event that pressure is exerted on layer 56 (e.g., downward pressure in the −Z direction), subspacers SCS can help prevent undesired contact between the opposing inner surfaces of layers 56 and 58. Subspacers SCS are not in constant contact with layer 58, which helps reduce wear on layer 58 and reduces the risk of scratching layers 102 and thereby producing particles that could contaminate liquid crystal layer 52. Column spacers MCS and SCS are shown as being adjacent to one another in FIG. 4, but may be spaced apart by any suitable distance. There may be, for example, a column spacer (i.e., a main or subspacer column spacer) in each row and column of black matrix 92 (e.g., a column spacer at each of the four corners of each pixel) or column spacers may be arranged more sparsely on display 14 (e.g., every two or three rows and/or every two or three columns of pixels or more).

The thickness of black matrix layer 92 may be about 1.5-2 microns, more than 1.4 microns, less than 2.1 microns, more than 0.1 microns, more than 0.3 microns, more than 0.8 microns, less than 5 microns, less than 4 microns, less than 3 microns, 2-10 microns, 1-7 microns, 2-8 microns, 0.5-5 microns, or other suitable thickness. The thickness of color filter layer 98 may be about 2-3 microns, more than 1.5 microns, less than 3.5 microns, more than 0.1 microns, more than 0.3 microns, more than 0.8 microns, less than 5 microns, less than 4 microns, less than 3 microns, 2-10 microns, 1-7 microns, 2-8 microns, 0.5-5 microns, or other suitable thickness. The thickness of overcoat layer 100 may be about 2-3 microns, more than 1.5 microns, less than 3.5 microns, more than 0.1 microns, more than 0.3 microns, more than 0.8 microns, less than 5 microns, less than 4 microns, less than 3 microns, 2-10 microns, 1-7 microns, 2-8 microns, 0.5-5 microns, or other suitable thickness. The thickness of the portions of main column spacers MCS that extends through layer 52 (i.e., the thickness of layer 52) may be about 3.4 to 3.5 microns, more than 3 microns, less than 5 microns, more than 0.1 microns, more than 0.3 microns, more than 0.8 microns, less than 5 microns, less than 4 microns, less than 3 microns, 2-10 microns, 1-7 microns, 2-8 microns, 0.5-5 microns, or other suitable thickness.

Layers 92, 98, and 100 may be formed from a polymer such as acrylic. The polymer used in forming layers 92, 98, and 100 may be subject to undesirable plastic deformation if layer 56 is bent inwardly due to the application of excessive force on the surface of display 14, thereby causing layer 56 to bend inwardly more than desired. Column spacers MCS and/or SCS may be formed from an acrylic or other polymer with less plasticity than the polymer used in forming layers 92, 98, and 100, which may help reduce plastic deformation and reductions in the gap between layers 56 and 58.

In conventional column spacer designs, the polymer that forms the main column spacers and subspacers rests on the exposed surface of the overcoat layer, so that portions of the overcoat layer, color filter layer, and black matrix plastically deform when pressure is applied. This plastic deformation permanently reduces the height of the column spacers and can lead to undesired gray spots on a display.

With arrangements of the type shown in FIG. 4, base 104 of column spacers MCS penetrates through layers 98 and 100 and contacts black matrix 92, so there is no possibility of deformation of layers 98 and 100 when pressure is applied to column spacer MCS. Column spacer MCS is formed from a material that has less plasticity than layers 98 and 100, so by forming column spacer MCS so that base 104 of column spacer 104 contacts layer 92 rather than resting on layer 98 or layer 100, the total amount of plastic deformation in the column spacer structures of display 14 when force is applied to display 14 is reduced. This reduces the likelihood of forming undesired gray spots on display 14.

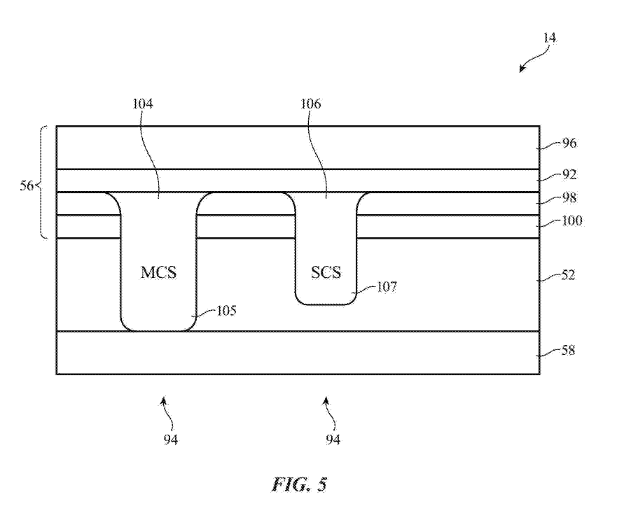

In the illustrative configuration of FIG. 4, base 106 of subspacer SCS has been formed in contact with the surface of overcoat layer 100 (i.e., the surface of overcoat layer 100 nearest the inner side of layer 56 which is adjacent to layer 52). As a result, portions of layers 98 and 100 under the subspacer column spacer in FIG. 4 may be subject to plastic deformation when force is applied to the subspacer column spacer. If desired, subspacer SCS may be extended to the surface of black matrix layer 92. As shown in FIG. 5, for example, base 106 of subspacer SCS may extend through layers 98 and 100 and may contact black matrix 92. Configurations in which column spacers 94 are formed from a dark material (e.g., black photoimageable polymer) and penetrate through black matrix 92 to contact substrate 96 may also be used. Arrangements of the type shown in FIGS. 4 and 5 are advantageous because the presence of black matrix 92 between column spacers 94 and substrate 96 helps hide column spacers 94 from view by viewer 48.

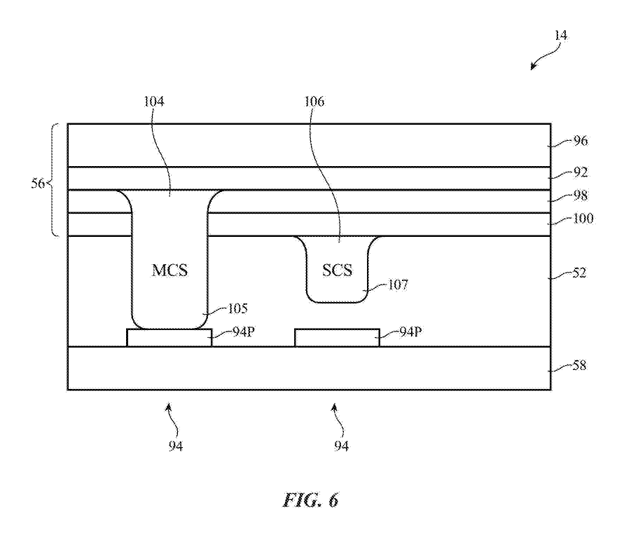

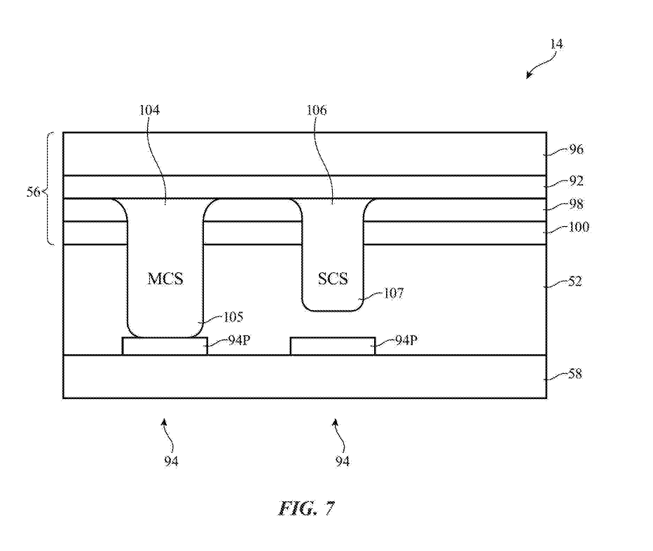

FIGS. 6 and 7 show versions of the respective column spacer arrangements of FIGS. 4 and 5 in which column spacers 94 have been provided with column spacer structures on layer 58 (e.g., on top of the layer of thin-film transistor circuitry on the surface of thin-film transistor layer 58 that faces layer 52). As shown in FIGS. 6 and 7, for example, column spacers 94 may have pads 94P that are aligned with corresponding portions of main column spacer MCS and subspacer SCS. To help reduce plastic column spacer deformation in response to pressure on display 14, column spacer structures such as column spacer pads 94P of column spacers 94 of FIGS. 6 and 7 may be formed from a polymer such as an acrylic with less plasticity than layers 98 and 100 (e.g., the same material used in forming column spacers MCS and SCS). In general, any suitable material may be used in forming pads 94P (e.g., polymer, inorganic dielectric, metal, etc.). To help reduce the generation of particles of alignment layers 102 that might contaminate layer 52, the tips of columns spacers MCS and SCS and/or the surfaces of pads 94P may be free of alignment layer material (i.e., layers 102 may not extend over tips 105, tips 107, and pads 94P).

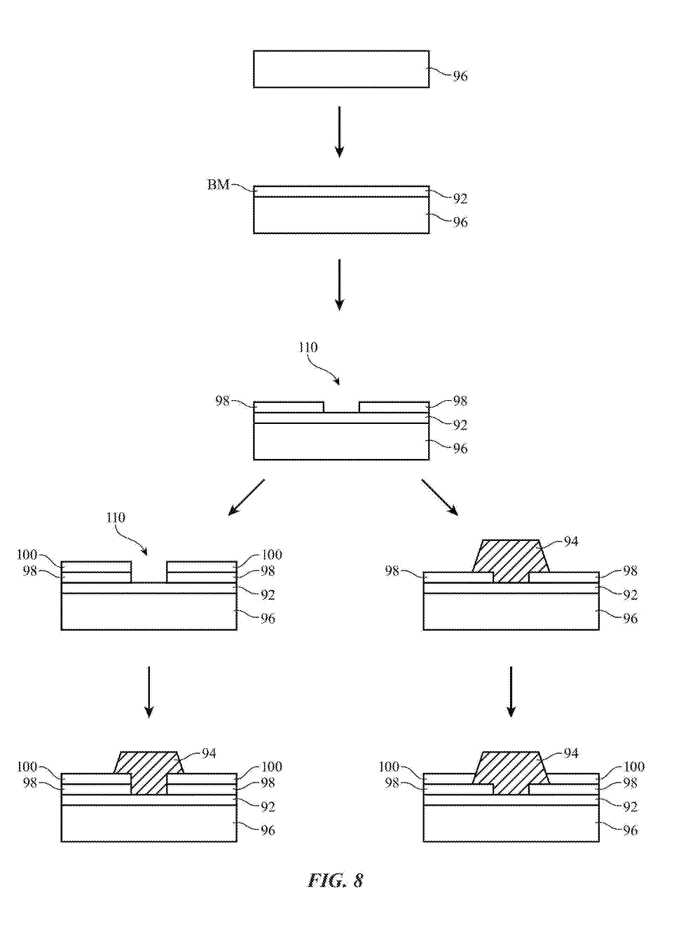

FIG. 8 shows illustrative steps involved in forming column spacers 94. As shown in FIG. 8, substrate 96 may initially be coated with a patterned black matrix layer such as black matrix 92 (e.g., by deposition of a blanket film of photoimageable black polymer and use of photolithography to pattern the deposited film). Black matrix 92 may have openings to receive color filter elements. Color filter element layer 98 (e.g., a layer with areas of red color filter elements, areas with green color filter elements, and areas with green color filter elements) may be patterned onto layer 92 (e.g., layers of different colored photoimageable color filter element polymer may be deposited as blanket films and patterned using photolithography). During the use of photolithography to pattern each colored portion of layer 98, column spacer openings such as opening 110 of FIG. 8 may be formed. After forming column spacer openings such as opening 110 in color filter element layer 98, processing may continue using the approach illustrated on either the left or right side of FIG. 8.

With the arrangement shown on the left of FIG. 8, overcoat layer 100 is deposited over color filter element layer 98 and patterned using photolithography to form openings in alignment with the openings in color filter element layer 98. By patterning overcoat layer 100 onto layer 98 in this way, openings such as opening 110 can be formed that pass through both layer 98 and layer 92 before column spacer deposition and patterning operations are used to form column spacer 94 (shown in the lower left corner of FIG. 8).

With the arrangement shown on the right of FIG. 8, column spacers 94 are patterned onto layer 56 after forming openings such as opening 110 in layer 98 but before depositing overcoat layer 100. Layer 100 may be formed from a low-viscosity acrylic and may surround column spacers 94 when layer 100 is deposited after column spacers 94 have been formed as shown on the lower right of FIG. 8. By depositing layer 100 in this way after column spacers 94 have been formed in the openings 110 in layer 98, layer 100 need not be formed from a photoimageable polymer. This allows a mask patterning step (photolithography step) to be omitted from the fabrication process (i.e., layer 100 can be deposited without using photolithography to form openings in alignment with the openings in layer 98 as is the case when using the approach on the left side of FIG. 8).

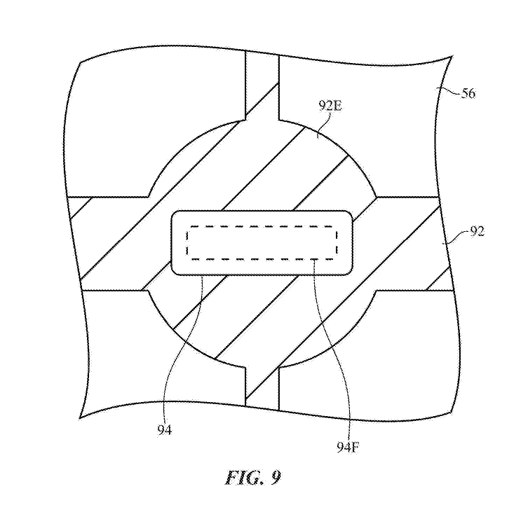

FIG. 9 is a top view of a portion of layer 56 showing how black matrix 92 may have a locally enlarged portion such as portion 92E at the intersection of each horizontal and vertical black matrix line (as an example). Column spacer 94 may be formed in the portion of color filter layer 56 that overlaps enlarged portion 92E. When viewed in the top view orientation of FIG. 9, the tip of column spacer 94 overlaps narrower column spacer footer portion 94F (i.e., the column spacer base), which penetrates into opening 110 in the underlying polymer layers such as layers 98 and 92 of FIG. 8. Column spacers 94 may have any suitable outline. For example, the shape of column spacers 94 when viewed from above (i.e., the footprint of column spacer 94) may be circular, may be oval, may be rectangular, may be rectangular with rounded corners, or may have other shapes with straight and/or curved edges.

The foregoing is merely illustrative and various modifications can be made by those skilled in the art without departing from the scope and spirit of the described embodiments. The foregoing embodiments may be implemented individually or in any combination.

What is claimed is:

1. A display, comprising:
first and second layers that are separated by a gap, wherein the first layer has a substrate, a black matrix layer on the substrate, a color filter element layer on the black matrix layer, and an overcoat layer on the color filter element layer;
a liquid crystal layer that fills the gap; and
column spacers on the first layer that have opposing tips and bases, wherein each tip penetrates into the liquid crystal layer and wherein each base penetrates through openings in the overcoat layer and color filter element layer and contacts the black matrix layer.

2. The display defined in claim 1 wherein the column spacers are main column spacers having a first height and wherein the display further comprise subspacer column spacers having a second height that is less than the first height.

3. The display defined in claim 2 wherein the subspacer column spacers each have a subspacer base and an opposing subspacer tip that penetrates into the liquid crystal layer.

4. The display defined in claim 3 wherein the subspacer bases contact the black matrix.

5. The display defined in claim 4 wherein the first layer comprises a color filter layer and wherein the color filter element layer has an array of color filter elements of different colors that overlap openings in the black matrix.

6. The display defined in claim 3 wherein the subspacer bases rest on the overcoat layer.

7. The display defined in claim 6 wherein the first layer comprises a color filter layer and wherein the color filter element layer has an array of color filter elements of different colors that overlap openings in the black matrix.

8. The display defined in claim 3 wherein the first layer comprises a color filter layer, wherein the color filter element layer has an array of color filter elements of different colors that overlap openings in the black matrix, and wherein the second layer comprises a thin-film transistor layer.

9. A method, comprising:
patterning a black matrix layer onto a clear substrate;
forming a color filter element layer over the black matrix, wherein the color filter element layer includes color filter elements of multiple colors and has openings that overlap the black matrix layer; and
forming an array of column spacers each of which has a base that passes through a respective one of the openings in the color filter element layer and that contacts the black matrix layer.

10. The method defined in claim 9 further comprising patterning an overcoat layer onto the color filter element layer before forming the array of column spacers.

11. The method defined in claim 10 wherein patterning the overcoat layer comprises forming openings in the overcoat layer using photolithography each of which is aligned with a respective one of the openings in the color filter element layer.

12. The method defined in claim 11 wherein forming the array of column spacers comprises forming the bases of the column spacers so that each base passes through one of the openings in the overcoat layer and one of the aligned openings in the color filter element layer.

13. The method defined in claim 9 further comprising depositing an overcoat layer onto the color filter element layer after forming the array the column spacers.

14. A display, comprising:
upper and lower polarizers;
a color filter layer and a thin-film transistor layer interposed between the upper and lower polarizers; and
a liquid crystal layer between the color filter layer and the thin-film transistor layer, wherein the color filter layer has a glass substrate, a layer of opaque material on the glass substrate with openings, a color filter element layer that forms color filter elements overlapping the openings in the layer of opaque material and that has color filter element layer openings, and column spacers each having a tip that penetrates into the liquid crystal layer and an opposing base that passes through a respective one of the color filter element layer openings and that contacts the layer of opaque material.

15. The display defined in claim 14 wherein the color filter element layer has a first plasticity and wherein the column spacers have a second plasticity that is less than the first plasticity.

16. The display defined in claim 15 wherein the color filter layer further comprises an overcoat layer on the color filter element layer.

17. The display defined in claim 16 wherein the bases of the column spacers each pass through the overcoat layer.

18. The display defined in claim 15 wherein the column spacers are main column spacers that penetrate into the liquid crystal layer a first distance and wherein the color filter layer further comprises subspacers that penetrate into the liquid crystal layer a second distance that is less than the first distance.

19. The display defined in claim 18 further comprising a plurality of column spacer pads on the thin-film transistor layer each of which is aligned with a respective one of the column spacers.

20. The display defined in claim 19 wherein the column spacer pads are formed from a material with a plasticity that is less than the first plasticity.
